(19) United States
(12) Patent Application Publication
(10) Pub. No.: US 2005/0267830 A1
(43) Pub. Date: Dec. 1, 2005

(54) Method and apparatus for funding a future liability of uncertain cost

(75) Inventors: Luis J. Diaz, Green Brook, NJ (US); James A. Digiorgio, Green Brook, NJ (US)

Correspondence Address: OBLON, SPIVAK, MCCLELLAND, MAIER & NEUSTADT, P.C., 1940 DUKE STREET, ALEXANDRIA, VA, 22314, US

(73) Assignee: IDT Corporation, Newark, NJ (US)

(21) Appl. No.: 10/855,336

(22) Filed: May 28, 2004

(51) Int. Cl. G06F 17/60

(52) U.S. Cl. 705/36; 705/35

(57) ABSTRACT

A method and apparatus for funding a future liability of uncertain cost which includes: considering the present cost of a liability and the projected due date of the future liability; estimating the future liability of uncertain cost; and administering a trust in a manner that reduces the uncertain cost of the future liability. The estimation of the future liability may be based on the expected due date of the liability and the escalation rate of the liability associated with a specified index. Administering the trust may include issuing floating rate zero coupon notes to generate trust assets and investing those assets in a manner that reduces the uncertainty of the cost of the future liability.

### BACKGROUND OF THE INVENTION

1. Field of the Invention

This invention relates generally to the funding of a future liability of uncertain cost. In one embodiment, this invention relates to administering a trust composed of assets using an investment plan so that the uncertainty of the cost of a future patent liability is reduced.

2. Discussion of the Background

The importance of technological innovation continues to rise in today's economy. As a result, companies continue to invest more of their resources into research and development of those technologies. As the importance of technology continues to increase, companies are forced to invest resources to protect their technologies. This protection is typically in the form of patents.

The protection provided by a patent does not come without costs. There are the direct costs of obtaining the patent, the indirect costs of administering the patent via licensing, as well as the future liabilities resulting from possible litigation. While the direct and indirect costs are relatively easy to predict, future liability costs are not easily predicted or funded.

Some liability costs relating to a patent are relatively certain. One such certainty stems from the fact that if a patent is not actively enforced the patent is essentially useless and creates no future liability. Unfortunately, enforcing a patent is at times going to result in extensive litigation which will result in extensive litigation costs.

In general, a company can attempt to self-insure for future liabilities of uncertain cost by acquiring a portfolio of securities, investing in mutual funds, or making some other form of investment. Mutual funds lower the risk of investing assets by combining the assets of many individuals into a common fund and investing in a diversity of other assets. However, programs such as this are managed to maximize yield based on the market, and have no direct relationship to the future liability of uncertain cost. Therefore, attempting to fund a relatively certain future liability of uncertain cost in this manner still leaves a significant risk that the future liability will not be adequately funded.

### SUMMARY OF THE INVENTION

Against that background, the Applicants developed the present invention, a method and apparatus for funding a future liability of uncertain cost. As one non-limiting example, a trust is used to reduce the uncertainty of the future liability cost.

The present invention also provides a method and apparatus for funding a future patent liability of uncertain cost using an intellectual property investment plan funded using ownership units held in a trust composed of technology and intellectual property assets. The intellectual property investment plan may be implemented using ownership units in a limited partnership or other legal entity.

Further, according to another non-limiting embodiment, the ownership units may be generated by the issuance of floating rate zero coupon notes having a scheduled maturity date and being redeemable. The method and apparatus for funding a future patent liability may also project the future cost of the liability based on when the liability is expected to come due and a projected escalation rate associated with a specified index. The method and apparatus may then calculate the issue price of the ownership units in the intellectual property trust by discounting the net present value of future revenue streams of the trust based on the expected maturity at a rate that represents the intellectual property owner's projected entitlement net of a risk premium.

### BRIEF DESCRIPTION OF THE DRAWINGS

These and other advantages of the invention will become more apparent and more readily appreciated from the following detailed description of the exemplary embodiments of the invention taken in conjunction with the accompanying drawings, where:

FIG. 1 illustrates a flow chart including the activities of the trust; and

FIG. 2 illustrates a computer that may be used to implement the method.

### DESCRIPTION OF THE EMBODIMENTS

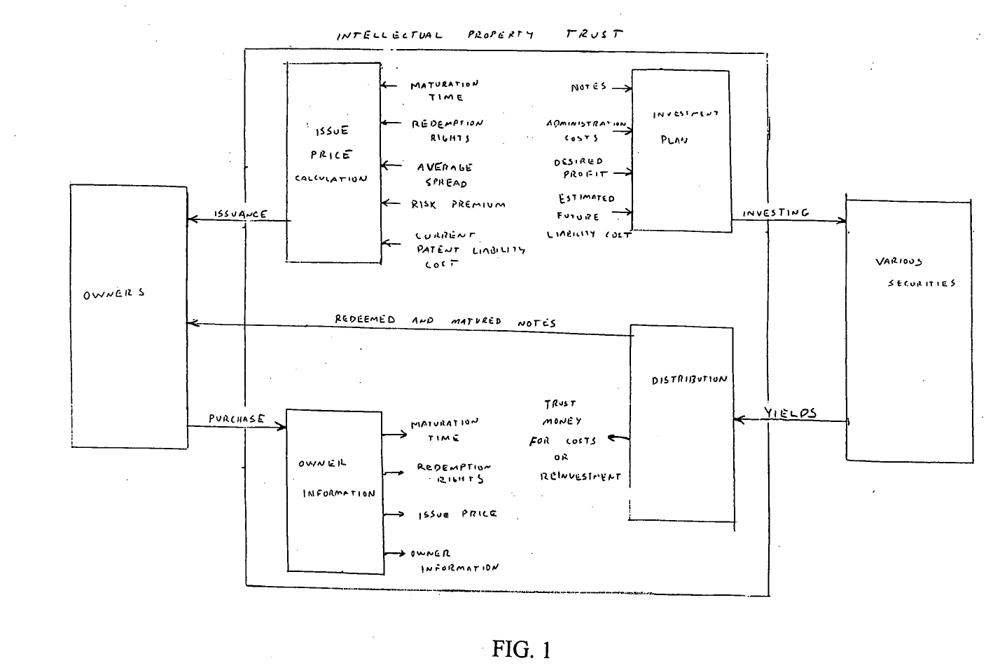

A first non-limiting embodiment of the present invention, as shown in FIG. 1, provides a method and apparatus for funding a future patent liability of uncertain cost using an intellectual property investment plan funded with ownership units held in a trust composed of technology and intellectual property assets. This embodiment may be implemented in a limited partnership or other legal entity.

This embodiment funds a future patent liability of uncertain cost. The uncertain costs may arise from future patent litigation and even future patent licensing efforts. These litigation costs vary depending on the type and duration of the litigation, and as a result are difficult to predict. Similarly, the negotiation costs can vary depending on the duration and depth of the negotiation.

The method of the present invention reduces risk associated with the future liability by estimating the uncertain cost of the future liability using factors including current patent liability costs, current inflation rates, and projections for the inflation rate of patent liability costs. The intellectual property trust is then administered to invest assets in a manner that will cover the estimated future liability costs.

Using this method, the burden of risk associated with the future liability of uncertain cost is shifted from the patent holder to the limited partnership or other legal entity administering the intellectual property trust. A patent holder may alleviate the burden of the future liability of an uncertain cost for a particular piece of intellectual property by purchasing ownership units in the trust which in turn makes accordingly. Essentially, this method allows a patent holder to transform the uncertain cost of the future liability into the cost of obtaining and enforcing the patent which is easily managed.

Funding and Operation of the Trust

The funding of a trust in this embodiment may be generated by the issuance of redeemable floating rate zero coupon notes having a specified maturity. A floating rate zero coupon note does not pay interest during the life of the note, but instead may be purchased at a discount from the note's face value, which is the value the note is worth once it matures. The floating rate zero coupon note provides a rate of return over the life of the note that will fund the future patent liability, but the return will only be paid in full when the note matures.

The intellectual property trust may issue floating rate zero coupon notes in order to generate assets used to invest in securities to cover the cost of the future patent liability. The administering of the intellectual property trust includes calculating the issue price for the floating rate zero coupon notes. In general, bond prices have an inverse relationship with interest rates meaning that if interest rates increase bond prices typically decrease. Similarly, the floating rate zero coupon notes have an inverse relationship with interest rates. The issue price calculation, as shown in FIG. 1, includes considering information such as the maturation time, redemption rights, present cost of patent liability, average projected spread between the inflation rate for patent liability and investment yields, and a risk premium linked to the volatility of the spread. Other factors known to those of skill in the art may also be considered.

The trust may issue floating rate zero coupon notes with different maturity times. Notes with a longer maturity time are issued at a greater discount from the notes' face value. The larger discount is a recognition of the time value of money.

The redemption rights of the floating rate zero coupon notes allow the notes' owner to redeem the notes at anytime prior to maturity with payment of a penalty according to a specified schedule of penalties designated in the purchase contract. The redemption value calculation of the note considers the cost of the patent liability at the time of purchase, the escalation in cost of the patent liability since purchase as measured by the specified index, the unamortized discount or premium balance, the amount of time prior to maturation that redemption occurs, and the penalty amount specified in the schedule of penalties. The issue price of the notes is inversely related to the severity of the schedule of penalties. Notes are issued at a greater discount from face value if the schedule of penalties for early redemption is more severe. The reasoning is that with a severe redemption penalty fewer notes will be redeemed prior to maturation, and as a result the trust is able to manage their assets and investments with a higher predictability.

The schedule of penalties of the floating rate zero coupon notes may vary. A schedule of penalties may include a single early withdrawal penalty that is charged regardless of when the redemption occurs prior to maturity. Alternatively, the schedule of penalties may provide a redemption penalty that decreases either continuously or period-by-period as the redemption occurs closer in time to the maturity of the note. The period-by-period decrease could be implemented using a monthly, yearly, or other period for the schedule. Other schedules of penalties known to those skilled in the art may also be considered.

The average projected spread between the inflation rate for patent liability and investment yields is also considered in calculating the issue price. The average spread between the inflation rate for patent liability and investment yields is the projected amount of money the trust will make in excess of the increase in patent liability costs. A larger amount of projected excess will allow the notes to be issued at a greater discount from face value. The reasoning is that the risk assumed by the trust in alleviating the uncertainty of the future patent liability cost is decreased.

The risk premium considered in the issue price calculation relates to the volatility of the average spread. If the volatility of the average spread between inflation for patent liability and investment yields is slight, the risk premium charged by the trust is going to decrease, and therefore the issue price of the notes will decrease. A relatively constant average spread decreases the risk involved in the trust alleviating the uncertainty of the future patent liability cost.

Essentially, the issue price of the floating rate zero coupon notes is the amount charged by the intellectual property trust to alleviate the burden of the future liability of uncertain cost by the method of the claimed invention. The issue price of the floating rate zero coupon notes is the price for an ownership unit in the trust, and represents the present value of the future revenue streams of the trust based on the expected maturity at a rate that represents the intellectual property owner's net projected entitlement of a risk that remains with the owner.

Once, the issue price for the floating rate zero coupon notes is calculated. The notes are available for purchase at the issue price. When the notes are purchased the trust records information relating to the purchase, as shown in FIG. 1. The information recorded includes the maturation time of the note, the redemption rights including the schedule of penalties, the issue price, and owner information such as contact information. Other information that is determined valuable to the management of the trust may also be recorded.

Further, the method provides an estimation of a future patent liability of uncertain cost whose projected due date and current patent liability costs are known. This estimation is similar to the estimation of future college costs as described in Roberts (U.S. Pat. No. 4,642,768, hereafter “the '768 patent”) and Roberts et al. (U.S. Pat. No. 4,752,877, hereafter “the '877 patent”). The entire contents of the '768 patent and the '877 patent are herein incorporated by reference.

The method estimates the expected future cost of the patent liability based on the projected due date and a projected escalation rate associated with a certain specified index. An escalation rate may be calculated using the following equation (as a non-limiting example):

$$ER = {( \frac{Ending\_Value}{Beginning\_Value} )}^{( \frac{1}{\# \_of \_years} ) - 1} ,$$

where ER is the escalation rate.

This method may use current interest rates and projected interest rates to calculate the specified index. A projected escalation rate associated with the interest rate index may be calculated using the equation (as a non-limiting example):

$$PER = {( \frac{Projected\_Interest \_Rate}{Current\_Interest \_Rate} )}^{( \frac{1}{\# \_of \_years} ) - 1} ,$$

where PER is the projected escalation rate. The method may also use a specified index associated with past patent liability costs and current patent liability costs. The projected escalation rate in this embodiment would be assumed to be the same as the escalation rate of a past specified number of years, and would be calculated using the following equation (as a non-limiting example):

$$PER = {( \frac{Current\_Patent \_Liability \_Cost}{Past\_Patent \_Liability \_Cost} )}^{( \frac{1}{\# \_of \_years} ) - 1} .$$

Further, the method may use a weighted average using the projected escalation rate calculated from the current and projected interest rates and the projected escalation rate calculated from the current and past liability costs. The following equation is a weighted average equation that may be used (as a non-limiting example):

$$PER = A \times {( \frac{Current\_Patent \_Liability \_Cost}{Past\_Patent \_Liability \_Cost} )}^{( \frac{1}{\# \_of \_years} ) - 1} - ( 1 - A ) \times {( \frac{Projected\_Interest \_Rate}{Current\_Interest \_Rate} )}^{( \frac{1}{\# \_of \_years} ) - 1} ,$$

where A and (1-A) are weights and defined as a number between 0 and 1. In another non-limiting example, one of skill in the art may use a historical regression analysis of prior years to determine the weighting that would most closely track the escalation rate of patent liability costs.

The projected escalation rate is then used to estimate the future patent liability costs. This estimation may be calculated by multiplying the current patent liability cost with the projected escalation rate. The result is the estimated future patent liability cost that may be used by the trust in implementing an appropriate investment plan.

Investing Trust Assets

As shown in FIG. 1, the method may use the estimation of the future patent liability to determine how the trust should invest the assets generated from the issuance of the floating rate zero coupon notes. In order to alleviate the uncertainty of the future patent liability cost, the fund may invest the assets to cover the estimated future patent liability, the floating rate zero coupon notes that mature and are redeemed prior to maturation, the administration costs of the trust, and the desired profit margin. The yields earned from the investments would then be distributed accordingly to the note owners and the trust. Yields retained by the trust could then be reinvested.

The investments of the trust may include U.S. Treasury Securities, U.S. agency debt securities, adjustable rate mortgages, corporate bonds, debt securities issued by supranational bodies such as World Bank, money market instruments, repurchase agreements, municipal debt, and various forms of corporate equity securities. Other investments known to those of skill in the art may also be considered.

Computer and System

This invention may be implemented using a conventional general purpose computer or micro-processor programmed according to the teachings of the present invention, as will be apparent to those skilled in the computer art. Appropriate software can readily be prepared by programmers of ordinary skill based on the teachings of the present disclosure, as will be apparent to those skilled in the software art.

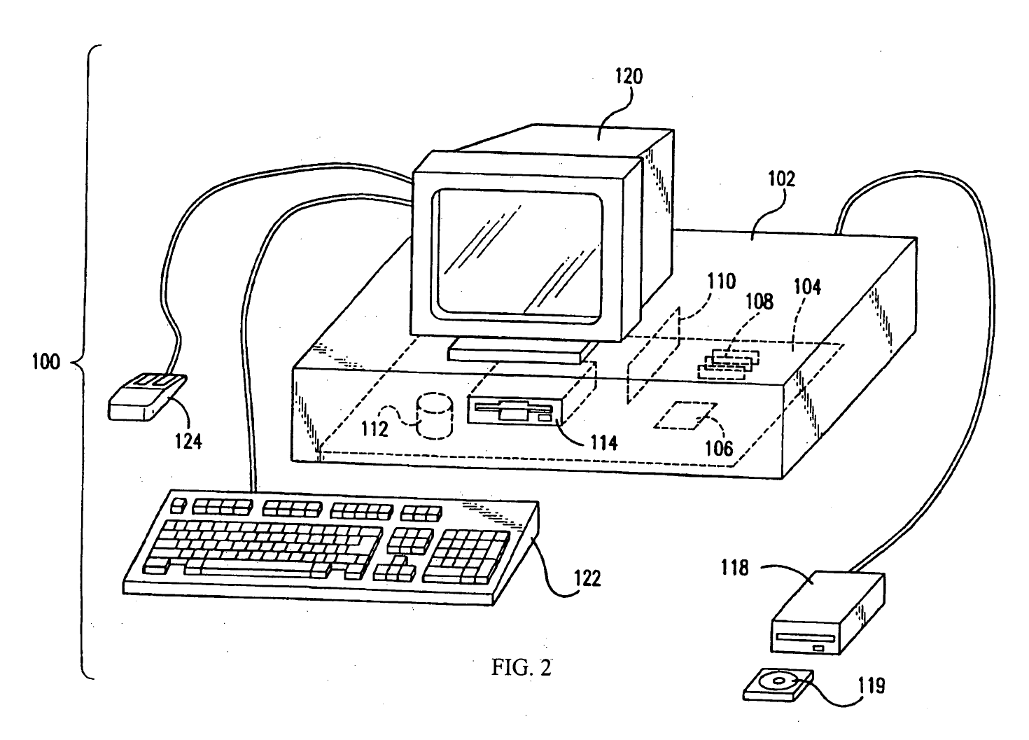

A non-limiting example of a computer 100 as shown in FIG. 2 may implement the method of the present invention, wherein the computer housing 102 houses a motherboard 104 which contains a CPU 106, memory 108 (e.g., DRAM, ROM, EPROM, EEPROM, SRAM, SDRAM, and Flash RAM), and other optical special purpose logic devices (e.g., ASICS) or configurable logic devices (e.g., GAL and reprogrammable FPGA). The computer 100 also includes plural input devices, (e.g., keyboard 122 and mouse 124), and a display card 110 for controlling a monitor 120. Additionally, the computer 100 may include a floppy disk drive 114; other removable media devices (e.g. compact disc 119, tape, and removable magneto-optical media (not shown)); and a hard disk 112 or other fixed high density media drives, connected using an appropriate device bus (e.g., a SCSI bus, an Enhanced IDE bus, or an Ultra DMA bus). The computer may also include a compact disc reader 118, a compact disc reader/writer unit (not shown), or a compact disc jukebox (not shown), which may be connected to the same device bus or to another device bus.

As stated above, the system includes at least one computer readable medium. Examples of computer readable media are compact discs 119, hard disks 112, floppy disks, tape, magneto-optical disks, PROMs (e.g., EPROM, EEPROM, Flash EPROM), DRAM, SRAM, SDRAM, etc. Stored on any one or on a combination of computer readable media, the present invention includes software for controlling both the hardware of the computer 100 and for enabling the computer to interact with a human user. Such software may include, but is not limited to, device drivers, operating systems and user applications, such as development tools. Such computer readable media further includes the computer program product of the present invention for performing the inventive method herein disclosed. The computer code devices of the present invention can be any interpreted or executable code mechanism, including but not limited to, scripts, interpreters, dynamic link libraries, Java classes, and complete executable programs. Moreover, parts of the processing of the present invention may be distributed for better performance, reliability, and/or cost. For example, plural contingencies can be calculated in parallel to determine portions of the uncertain costs simultaneously and the results summed at the end.

The invention may also be implemented by the preparation of application specific integrated circuits or by interconnecting an appropriate network of conventional component circuits, as will be readily apparent to those skilled in the art.

The invention may further include the use of other investment types besides zero rate coupons. Derivatives based on such coupons may also be purchased to hedge against changing liability costs. Similarly, insurance may be purchased to offset a portion of the costs in the short term. For example, while a future liability may be sufficiently funded in 5 years, it may not be before then. Thus, the trust may invest in an insurance policy that is time-based that will pay the difference between the accumulated value and the actual liability if the liability occurs before the maturity date of the notes.

Obviously, numerous modifications and variations of the present invention are possible in light of the above teaching. It is therefore to be understood that within the scope of the appended claims, the invention may be practiced otherwise than as specifically described herein.

1. A method for funding a future patent liability of uncertain cost, comprising:
determining a current patent liability cost of a future patent liability and a projected due date of the future patent liability;
estimating an uncertain cost of the future patent liability; and
administering a trust to reduce uncertainty of the uncertain cost of the future patent liability.

2. The method according to claim 1, wherein the estimating is based on at least one of the current patent liability cost and a projected escalation rate associated with a specified index.

3. The method according to claim 2, wherein the administering a trust includes:
issuing at least one note and investing at least one trust asset to cover at least one of an estimated future patent liability, the at least one note, administration costs, and a desired profit margin.

4. The method of claim 3, wherein the at least one note includes at least one floating rate zero coupon note.

5. The method according to claim 4, wherein the issuing of at least one floating rate zero coupon note includes:
defining maturation dates of the at least one floating rate zero coupon note;
defining redemption rights of the at least one floating rate zero coupon note including a schedule of penalties for early redemption; and
calculating an issue price of the at least one floating rate zero coupon note.

6. The method according to claim 5, wherein the defining redemption rights includes:
calculating a redemption value of the at least one floating rate zero coupon note based on a present cost of at least one patent liability when purchased, an escalation in cost of the at least one patent liability since the at least one floating rate zero coupon note was purchased as measured by the specified index, an unamortized discount or premium balance, an amount of time prior to maturation that redemption occurs, and the schedule of penalties for early redemption.

7. The method according to claim 6, wherein when the at least one floating rate zero coupon note is purchased, note and owner information is recorded by the trust.

8. The method according to claim 7, wherein the note and owner information includes at least one of purchase price, date of maturation, note redemption rights, and owner contact information.

9. The method according to claim 5, wherein the schedule of penalties comprises a single penalty for early redemption regardless of when redemption occurs prior to maturation.

10. The method according to claim 5, wherein the schedule of penalties comprises a penalty that decreases as a date of maturation approaches.

11. The method according to claim 5, wherein the schedule of penalties comprises a penalty that decreases period-by-period as a date of maturation approaches.

12. The method according to claim 5, wherein the issue price is an amount charged to an owner of an at least one future liability for the trust to alleviate a burden of the at least one future patent liability.

13. The method according to claim 1, wherein the trust includes technology and intellectual property assets.

14. An apparatus for funding a future patent liability of uncertain cost, comprising:
means for considering a current patent liability cost of a future patent liability and a projected due date of the future patent liability;
means for estimating an uncertain cost of the future patent liability;
means for generating assets; and
means for investing assets to reduce uncertainty of the uncertain cost of the future patent liability.

15. The apparatus according to claim 14, wherein the means for generating assets includes a means for issuing at least one floating rate zero coupon note.

16. The apparatus according to claim 15, wherein the means for issuing at least one floating rate zero coupon note includes:
means for defining maturation dates for the at least one floating rate zero coupon note;
means for defining redemption rights of the at least one floating rate zero coupon note; and
means for calculating an issue price of the at least one floating rate zero coupon note.

17. A computer program product storing program instructions for execution on a computer system, which when executed by the computer system causes the computer system to perform a method for funding a future patent liability of uncertain cost, comprising:
considering a current patent liability cost of a future patent liability and a projected due date of the future patent liability;
estimating an uncertain cost of the future patent liability; and
administering a trust to reduce uncertainty of the uncertain cost of the future patent.

18. The computer program product according to claim 17, wherein the estimating is based on at least one of the current patent liability cost, the projected due date, and a projected escalation rate associated with a specified index.

19. The computer program product according to claim 18, wherein the administering a trust includes:
issuing at least one floating rate zero coupon note and investing at least one trust asset to cover at least one of an estimated future patent liability, the at least floating rate zero coupon note, administration costs, and a desired profit margin.

20. The computer program product according to claim 19, wherein the issuing at least one floating rate zero coupon note includes:
defining maturation dates of the at least one floating rate zero coupon note;
defining redemption rights of the at least one floating rate zero coupon note including a schedule of penalties for early redemption; and
calculating an issue price of the at least one floating rate zero coupon note.
